(19) United States
(12) Patent Application Publication
(10) Pub. No.: US 2026/0320047 A1
(43) Pub. Date: Oct. 15, 2026

(54) SYSTEMS AND METHODS FOR STRUCTURED AND SEMI STRUCTURED NATURAL LANGUAGE PROCESSING METHOD AND SYSTEM FOR OPTIMIZING DATABASE QUERIES

(71) Applicant: JPMORGAN CHASE BANK, N.A., New York, NY (US)

(72) Inventors: Sudhakar KRISHNAMACHARI, Bengaluru (IN); James M LONG, Jersey City, NJ (US)

(21) Appl. No.: 19/228,370

(22) Filed: Jun. 4, 2025

(30) Foreign Application Priority Data
Apr. 11, 2025 (IN) 202511035420

(51) Int. Cl. G06F 16/2453; G06F 16/242

(52) U.S. Cl. CPC G06F 16/24542; G06F 16/243; G06F 16/2448

(57) ABSTRACT

In some embodiments, the techniques described herein relate to a method including: receiving, by an application executed on one or more processors, a user prompt; generating, by the application, an assisted user prompt; generating, by the application, system rules based on the prompt; generating, by the application, context based on the prompt; validating, by the application, an alignment of the prompt, the system rules, and the context; generating, by a LLM, a response to the prompt based on the system rules, the context, and the prompt; validating, by the application, the response based on a plan and one or more performance statistics; and providing, by the application, the validated response to an API interface.

### BACKGROUND

### 1. Field of the Invention

Embodiments generally relate to systems and methods for structured and semi structured natural language processing method and system for optimizing database queries.

### 2. Description of the Related Art

To generate accurate dataset from a backend data store or stores, conventional systems use data extraction technique like SQL or GraphQL or NoSQL specific syntax of the given datastore. Conventional systems and methods may include text to structured query language (“SQL”) conversion. Text-to-SQL systems converts natural language queries into SQL commands, enabling users to interact with searches using natural language rather than SQL like syntax. However, conventional systems rely heavily on a user prompt which can pose unclear questions or at least questions that a machine learning model or artificial intelligence system is unable to respond to. In a conventional system, for example, the user may not refer to a specific database or even a specific database value in a prompt, and/or variations, synonyms, typos, and/or vague expressions may be included in the prompt, and this causes machine learning models or artificial intelligence systems to be misled and not find a correct database. A robustness-specific database in conventional systems, with the natural language query, may also be unable to support practical applications involving complex scenarios with data definition language (“DDL”) context, code tables with tight bounds for large databases with millions or more of entries. Improved systems and methods proposed will be able to efficiently respond to natural language prompts, have improved accuracy, provide a high level of confidence, be able to search regardless of context length and document depth, be able to match data extraction components, and will use execution-based metrics to improve machine learning models and artificial intelligence systems.

### SUMMARY

Exemplary embodiments provide systems and methods for structured and semi structured natural language processing method and system for optimizing database queries. According to one embodiment, a method may include In some embodiments, the techniques described herein relate to a method including: generating, by an application executed on one or more processors, an assisted prompt based on a structured format, system rules based on the prompt; generating, by the application, context based on the prompt; validating, by the application, an alignment of the prompt, the system rules, and the context; generating, by a large language model (“LLM”), a response to the prompt based on the system rules, the context, and the prompt; validating, by the application, the response based on a plan and one or more performance statistics; and providing, by the application, the validated response to an application programming (“API”) interface.

Exemplary embodiments provide systems and methods for receiving, by an application executed on one or more processors, a user prompt; generating, by the application, an assisted user prompt based on the user prompt; generating, by the application, system rules based on the prompt; generating, by the application, context based on the prompt; validating, by the application, an alignment of the prompt, the system rules, and the context; generating, by a LLM, a response data to the prompt based on the system rules, the context, and the prompt; validating, by the application, the response data based on a plan and one or more performance statistics; and providing, by the application, the validated response to an API interface.

In some embodiments, the method may further comprise a step where a system rule generator including a LLM generates the system rules based on generated synthetic input data from a training data set of SQL queries. In some embodiments, the method may further comprise a step where context generator may generate the context comprising an augmented data definition language including one or more of an alias, a description, a code table, and a data dictionary, the context being within tight bounds. In some embodiments, the method may further comprise a step where a datastore interface may wrap the SQL and/or explanation for a fetch count and data fetch limit row. In some embodiments, the performance statistics may include one or more of an exact matching, a component matching, an execution-based metric, and a valid efficiency score. In some embodiments, the performance statistic may be the valid efficiency score calculated by:

$$VES = \frac{1}{N} {\sum }_{n = 1}^{N} 𝕀 ( {V}_{n} , {\hat{V}}_{n} ) \cdot R ( {Y}_{n} , {\hat{Y}}_{n} ) , \qquad ( 1 )$$

where

$$𝕀 ( {V}_{n} , {\hat{V}}_{n} ) = \{ \begin{matrix}1 , {V}_{n} = {\hat{V}}_{n} \\ 0 , {V}_{n} \neq {\hat{V}}_{n}\end{matrix} . \qquad ( 2 )$$

and N=a total number of test runs to generate the reports or modify data, n=to sum each of the metric as provided n refers to each of the test run stat, Y\hat{ }n is a predicted SQL query and Van is an executed result, Yn is the predicted SQL query of a corresponding ground truth SQL query, Vn is the executed result of the corresponding ground truth SQL query, and R (Yn, Y\hat{ }n) is a relative efficiency based on time impact and/or plan cost.

In some embodiments, the method may further comprise verifying, by a SQL validator executed by the one or more processors, the generated SQL against the response data based on one or more performance metrics. In some embodiments, the method may further comprise generating, by an application executed by one or more processors, an assisted user prompt based on an application programming interface (“API”) method call for data;

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for structured and semi structured natural language processing method and system for optimizing database queries, in accordance with embodiments.

FIG. 2 is a method for structured and semi structured natural language processing method and system for optimizing database queries, in accordance with embodiments.

FIG. 3 is a block diagram of a computing device for implementing certain embodiments of the present disclosure.

### DETAILED DESCRIPTION

Embodiments generally relate to systems and methods for structured and semi structured natural language processing method and system for optimizing database queries.

Conventional systems inability to efficiently and accurately obtain for specific information, modify the data store based on a user prompt in natural language, particularly as the context length increases. Improved systems and methods consistent with the present disclosure will be able to efficiently respond to natural language prompts, have improved accuracy, provide a high level of confidence, be able to obtain or modify data regardless of context length and document depth, be able to match SQL components, and will use execution-based metrics to improve machine learning models and artificial intelligence systems. Improved systems and methods may also support practical applications involving complex scenarios such as data definition language (“DDL”) requests, code tables with tight bounds, and large databases with several millions or more of entries.

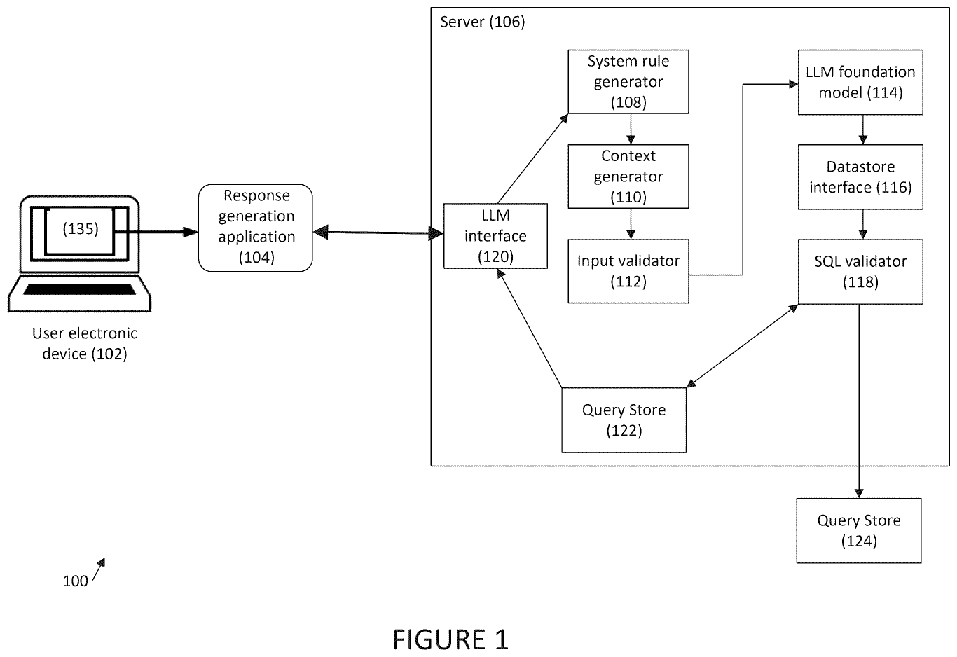

FIG. 1 is a block diagram of a system for structured and semi structured natural language processing method and system for optimizing database queries, in accordance with embodiments.

System 100 includes a user electronic device 102 executing a response generation application 104 available through user interface 135 and/or server 106 comprising a network or computer including a processor executing one or more software modules and a memory for storing data accessible by the one or more software modules and instructions to execute the one or more software modules. The one or more software modules may include system rule generator 108, context generator 110, input validator 112, a LLM foundation model 114, datastore interface 116, a SQL validator 118, and a LLM interface 118 that may include a prompt assist. One or more databases or data stores 120 of server 106 may be accessed and/or include instructions for the one or more software modules and/or data to be searched based on a user prompt. While a user may enter a user prompt in the structured unassisted, it is understood that a user prompt may be generated by another computer system, for example, to obtain or modify information. Such a data request may be made through an API interface, for example, through a method call that may have prompt information as a parameter to the method call. Data stores 120 may be one or more databases stored on a memory accessible by server 106 as part of the computer network and/or as a cloud database accessible by server 106. The prompt assist may modify the prompt based on metadata such as based on spellcheck corrections, code completion, comparison to a database of common words or phrases, parameter information, quick information, and/or member lists.

The response generation application 104 executed by one or more processors of user communication device 102 may be used to obtain or modify the data in the data store or stores connected. User communication device 102 may be a computer configured to communicate over a wired or wireless interface with a computer network or Internet with server 106. The account may be stored on an internal database of server 106 such as in a temporary or permanent database. In some embodiments, the account details may be part of an internal database such as a memory or a group of memories as part of a computer network comprising server 106. A prompt may be provided through user interface 135 by a user or the computer may generate a prompt based on a computer application such as a banking application, a client profile search, a financial institution search. In some embodiments, the response generation application 104 may be accessed by the computer application to conduct to obtain or modify data. In some embodiments, the response generation application 104 may respond to a call from an application programming interface (“API”) where the prompt is a parameter of the API and the response generation application 104 responds to the API with a result of the search that may include a pointer to a database or document, an excerpt of requested information, and/or a generated natural language and/or SQL response.

System rule generator 108 may include a LLM. System rule generator 108 may include generating one or more levels of rules in order to bind and/or interpret complex relationships within the prompt. System rule generator may apply a combination of generic, categorized, and/or specific rules.

System rule generator 108 may be trained based on generated synthetic input data from a training data set of complex SQL queries.

Context generator 110 may include generating one or more of an augmented data definition language (“DDL”) including an alias, a description, a code table, and/or a data dictionary. The generation may be within tight bounds to achieve minimal or near zero hallucination beyond the response accuracy bounds.

Context generator 110 may be trained based on generated synthetic input data from a training data set of complex SQL queries.

Input validator 112 may include validating one or more prompts, rules and/or context. Input validator 112 may pass feedback (not shown) regarding corrections to prompts, rules, and/or context to LLM interface 120. The feedback may be passed through an API interface.

Input validator 112 may ensure that the prompt, system rules, and/or context are aligned. If not aligned, the prompt, system rules, and/or context may be edited or feedback to the relevant generator for realignment with a determined alignment. This will increase efficiency and accuracy of the response. System rules may include one or more of one or more generic rules applicable across all requests, one or more categorized rules based on a domain or a sub-domain, the domain or sub-domain determined based on the prompt or a modification request, and/or one or more specific rules that are specific to the prompt.

LLM foundation model 114 may receive the prompt, rules, and/or context from input validator 112. LLM foundation model 114 may generate a SQL and/or an explanation based on the received prompt, rules, and/or context. LLM foundation model 114 may pass the SQL and/or the explanation to datastore interface 116.

Datastore interface 116 may wrap the SQL and/or explanation for a fetch count and/or a data fetch limit row.

SQL validator 118 may validate the SQL. SQL validator 118 may validate the SQL based on accuracy of generated query syntax, performance statistics. The performance statistics may be exact matching, component matching, execution-based metrics, and/or a valid efficiency score (“VES”). The exact matching may measure a percent of examples predicted SQL query that are a truth SQL query. The component matching may evaluate whether SQL components match including “SELECT,” “WHERE,” “GROUP BY,” “ORDER BY,” and “KEYWORDS.” The execution-based metrics may compare a final execution result content. The VES may be calculated according to the following equation:

$$VES = \frac{1}{N} {\sum }_{n = 1}^{N} 𝕀 ( {V}_{n} , {\hat{V}}_{n} ) \cdot R ( {Y}_{n} , {\hat{Y}}_{n} ) , \qquad ( 1 )$$

where

$$𝕀 ( {V}_{n} , {\hat{V}}_{n} ) = \{ \begin{matrix}1 , {V}_{n} = {\hat{V}}_{n} \\ 0 , {V}_{n} \neq {\hat{V}}_{n}\end{matrix} . \qquad ( 2 )$$

N=the total number of test runs to generate the reports or modify data.
n=to sum each of the metric as provided. n may refer to each of the test run stat.

Y\hat{ }n and V\hat{ }n may be the predicted SQL query and its executed results. Yn and Vn are those of the corresponding ground truth SQL query. R (Yn, Y\hat{ }n) may be the relative efficiency based on time impact and/or plan cost.

SQL validator 118 may verify the generated SQL against the generated response data, explain plan, and performance states. SQL validator 118 may evaluate and use multi-LLM model responses to accept high accuracy rated responses.

Query store 122 may receive the generated user prompt, system rules, context and the VES or other metric scores as history of records for ongoing system feedback and optimization.

Data stores 124 may receive the explanation and/or the SQL and provide a generated report, the explanation, and/or the SQL to LLM interface 120. Data stores 124 may maintain the history of execution to provide feedback for improving accuracy and assistance for performance and/or speed.

LLM interface 120 may be API driven. In some embodiments, LLM interface 120 may receive or output inputs directly to a user interface (e.g., user interface 135). LLM interface 120 may provide the generated report, the explanation, and/or the SQL to a connecting application (e.g., response generation application 104).

Although SQL is referenced above, it is understood that the present disclosure applies to any specific syntax for a given datastore such as SQL, GraphQL, or NoSQL.

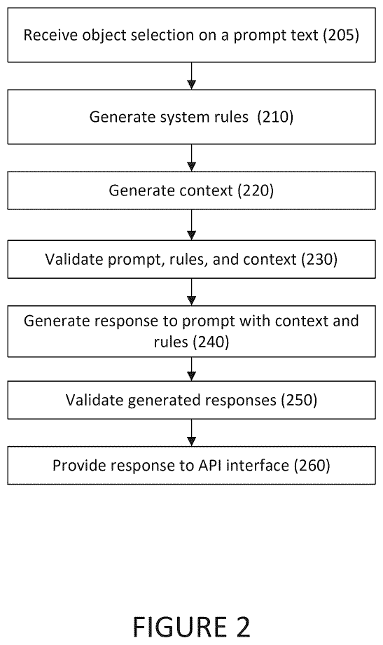

FIG. 2 is a method for structured and semi structured natural language processing method and system for optimizing database queries. The method may be stored as a list of instructions stored on a memory that when executed by one or more processors cause the one or more processors to perform the method.

Step 205 may include receiving, by an application executed by one or more processors, a user prompt and may generate an assisted user prompt.

Step 210 may include generating, by the application, system rules based on the prompt.

Step 220 may include generating, by the application, context based on the prompt.

Step 230 may include validating, by the application, an alignment of the prompt, the system rules, and/or the context.

Step 240 may include generating, by a LLM, a response to the prompt based on the system rules, the context, and the prompt.

Step 250 may include validating, by the application, the response based on a plan and one or more performance statistics. Step 250 may include forwarding by the application to a data store the validated prompt, system rules, context, metric stats.

Step 260 may include providing, by the application, the validated response to an API interface.

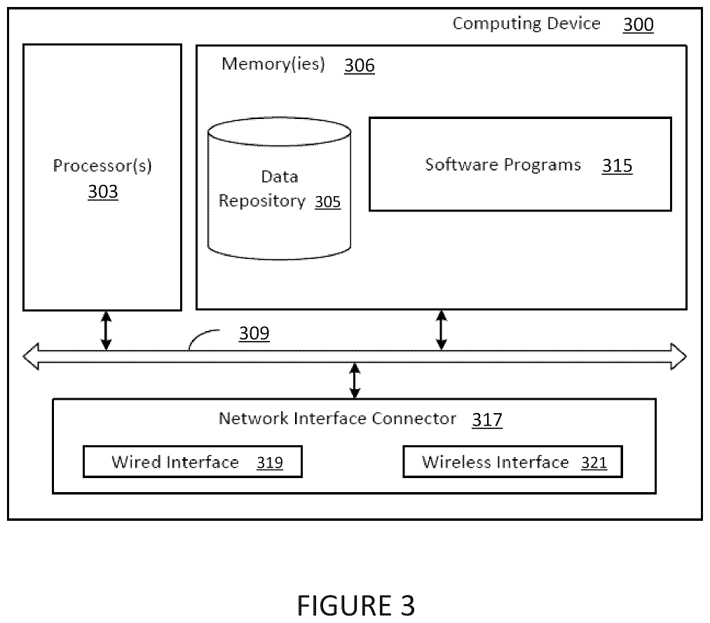

FIG. 3 is a block diagram of a computing device for implementing certain embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include Assembly, C, C++, Java, Python, Go, Rust, Clojure, Swift, Kotlin, Dart, C#and/or Javascript.

Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational or non-relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method comprising:
receiving, by an application executed on one or more processors, a user prompt;
generating, by the application, an assisted user prompt based on the user prompt, wherein the generating the assisted user prompt is based on metadata comprising one or more of spellcheck corrections, code completion, comparison to a database of common words or phrases, parameter information, quick information, and member list;
generating, by the application, system rules based on the prompt;
generating, by the application, context based on the prompt;
validating, by the application, an alignment of the prompt, the system rules, and the context;
generating, by a large language model (“LLM”) executed by the one or more processors, a response data to the prompt based on the system rules, the context, and the prompt;
validating, by the application, the response data based on a plan and one or more performance statistics by verifying, by a structured query language (“SQL”) validator executed by the one or more processors, generated SQL against the response data, an explain plan, and performance states, wherein the one or more performance statistics comprises a valid efficiency score that is calculated by:
$$VES = \frac{1}{N} {\sum }_{n = 1}^{N} 𝕀 ( {V}_{n} , {\hat{V}}_{n} ) \cdot R ( {Y}_{n} , {\hat{Y}}_{n} ) , \qquad ( 1 )$$
where
$$𝕀 ( {V}_{n} , {\hat{V}}_{n} ) = \{ \begin{matrix}1 , {V}_{n} = {\hat{V}}_{n} \\ 0 , {V}_{n} \neq {\hat{V}}_{n}\end{matrix} . \qquad ( 2 )$$
and N=a total number of test runs to generate the reports or modify data, n=to sum each of the metric as provided n refers to each of the test run stat, Y\hat{ }n is a predicted SQL query and V\hat{ }n is an executed result, Yn is the predicted SQL query of a corresponding ground truth SQL query, Vn is the executed result of the corresponding ground truth SQL query, and R (Yn, Y\hat{ }n) is a relative efficiency based on time impact and plan cost; and
providing, by the application, the validated response to an Application Programming Interface (“API”).

2. The method of claim 1, further comprising a system rule generator including a rule LLM that generates the system rules based on generated synthetic input data from a training data set of SQL queries.

3. The method of claim 1, further comprising a context generator that generates the context comprising an augmented data definition language including one or more of an alias, a description, a code table, and a data dictionary, the context being within tight bounds.

4. The method of claim 1, further comprising a datastore interface that wraps the SQL and/or explanation for a fetch count and data fetch limit row.

5. The method of claim 1, wherein the performance statistics include one or more of an exact matching, a component matching, an execution-based metric, and a valid efficiency score.

6. (canceled)

7. The method of claim 1, further comprising verifying, by a SQL validator executed by the one or more processors, the generated SQL against the response data based on one or more performance metrics.

8. A method comprising:
generating, by an application executed by one or more processors, an assisted user prompt based on an application programming interface (“API”) method call for metadata comprising one or more of spellcheck corrections, code completion, comparison to a database of common words or phrases, parameter information, quick information, and member list of a prompt;
generating, by the application, system rules based on the prompt;
generating, by the application, context based on the prompt;
validating, by the application, an alignment of the prompt, the system rules, and the context;
generating, by a large language model (“LLM”) executed by the one or more processors, a response to the prompt based on the system rules, the context, and the prompt;
validating, by the application, the response based on a plan and one or more performance statistics by verifying, by a structured query language (“SQL”) validator executed by the one or more processors, generated SQL against the response data, an explain plan, and performance states, wherein the one or more performance statistics comprises a valid efficiency score that is calculated by:
$$VES = \frac{1}{N} {\sum }_{n = 1}^{N} 𝕀 ( {V}_{n} , {\hat{V}}_{n} ) \cdot R ( {Y}_{n} , {\hat{Y}}_{n} ) , \qquad ( 1 )$$
where
$$𝕀 ( {V}_{n} , {\hat{V}}_{n} ) = \{ \begin{matrix}1 , {V}_{n} = {\hat{V}}_{n} \\ 0 , {V}_{n} \neq {\hat{V}}_{n}\end{matrix} . \qquad ( 2 )$$
and N=a total number of test runs to generate the reports or modify data, n=to sum each of the metric as provided n refers to each of the test run stat, Y\hat{ }n is a predicted SQL query and V\hat{ }n is an executed result, Yn is the predicted SQL query of a corresponding ground truth SQL query, Vn is the executed result of the corresponding ground truth SQL query, and R (Yn, Y\hat{ }n) is a relative efficiency based on time impact and plan cost; and
providing, by the application, the validated response to an Application Programming Interface (“API”).

9. The method of claim 8, further comprising a system rule generator including a rule LLM that generates the system rules based on generated synthetic input data from a training data set of SQL queries.

10. The method of claim 8, further comprising a context generator that generates the context comprising an augmented data definition language including one or more of an alias, a description, a code table, and a data dictionary, the context being within tight bounds.

11. The method of claim 8, further comprising a datastore interface that wraps the SQL and/or explanation for a fetch count and data fetch limit row.

12. The method of claim 8, wherein the performance statistics include one or more of an exact matching, a component matching, an execution-based metric, and a valid efficiency score.

13. (canceled)

14. The method of claim 8, further comprising verifying, by a SQL validator executed by the one or more processors, the generated SQL against the response data based on one or more performance metrics.
